(19) United States
(12) Patent Application Publication
(10) Pub. No.: US 2011/0269093 A1
(43) Pub. Date: Nov. 3, 2011

(54) ORTHODONTIC BRACKET AND ELASTOMERIC INSERT SYSTEM

(76) Inventor: Robert Lawson Waugh, JR., Athens, GA (US)

(21) Appl. No.: 13/095,475

(22) Filed: Apr. 27, 2011

Related U.S. Application Data
(60) Provisional application No. 61/329,274, filed on Apr. 29, 2010.

(51) Int. Cl. A61C 7/28

(52) U.S. Cl. 433/10

(57) ABSTRACT

An orthodontic bracket has a base, a fixed jaw extending from the base, and a movable jaw slidably engaging the base. The region between these jaws is designed to receive an archwire. A camming mechanism drives the movable jaw toward the fixed jaw to capture the archwire in the region between the jaws. Optionally, an elastomeric insert can be employed to hold the archwire between the jaws.

### RELATED APPLICATION

The present application is based on and claims priority to the Applicant's U.S. Provisional Patent Application 61/329,274, entitled “Orthodontic Bracket And Elastomeric Insert System,” filed on Apr. 29, 2010.

### BACKGROUND OF THE INVENTION

1. Field of the Invention

The present invention relates generally to the field of orthodontics. More specifically, the present invention discloses an orthodontic bracket.

2. Statement of the Problem

The prior art in the field of orthodontic brackets includes a wide variety of designs, including the broad category of self-ligating brackets. The self-ligating functionality includes hinged pivoting caps with various types of latches, sliding caps, sliding clips, and wire clips inserts and so on for holding an archwire in the slot of an orthodontic bracket. Some conventional self-ligating brackets can operate in a passive mode, in which the relationship between an archwire and the bracket's arch slot allows a range of motion and creates little friction between these components. Other conventional self-ligating brackets are intended to operate primarily in an active mode, in which the archwire is constrained within the arch slot to a degree sufficient to impart direct control over the orientation of the bracket on the archwire and thereby impart positive positioning forces to a tooth to which it is attached. However, it is believed that none of these prior-art brackets exhibit the capability for the practitioner to selectively alter the bracket's properties at will, without replacement of the bracket, among the following states: (1) a passive slot/wire relationship; (2) an active relationship that exerts positive control over the bracket; or (3) a lock-down mode that employs an elastomeric insert to create an intentional binding or locking connection from the slot to the wire.

Prior to the present invention, a practitioner was relegated to either removing and repositioning a new bracket, or making bends in the wire to achieve a desired interface between the slot and wire so as to improve a tooth's position. In many cases, the doctor's time or material expense required to provide such changes become barriers to providing optimal patient care, but not performing such steps might compromise the patient's overall result or extend the patient's treatment time.

3. Solution to the Problem

The present invention can be compared to a milling vise with block inserts. An inventory of inserts are intended to be easily removed, identified and replaced within the jaws provided by the present bracket assembly for a desired clinical advantage as a patient's treatment progresses. These inserts can have any of a wide variety of configuration, as will discussed below.

Alternatively, the present invention might be likened to a disc brake and a caliper, where the slots walls clamp together on the archwire as if it were the disc portion of a disc brake system. The selective use of inserts with varying configurations and mechanical properties offers the practitioner the ability to prescribe and record with accuracy the changes made for patient adjustments and perhaps then delegate the replacement of the insert with consistency and predictability.

The present orthodontic bracket has an eccentric cam mechanism configured for mechanical advantage in pushing a movable jaw tightly in the direction of a fixed jaw with a significant vise-like force and progressive closure. Such a capability provides entirely new benefits to the practitioner. The present invention also departs from the typical metal-to-metal relationship between the metallic archwire and bracket through the use of a family of non-metallic inserts for each of the various treatment modes described above.

Further, none of the prior-art brackets employ a closure mechanism that is capable of securely maintaining the bracket in a closed position, and simultaneously exerting concentrated forces capable of clamping an insert and archwire tightly within the bracket. The option of clamping or immobilizing the bracket on the archwire provides many extremely useful options to the practitioner during treatment. One problem that is associated with generating corrective forces for tooth movement is the handling of undesirable reciprocal forces. Such reciprocal forces can create additional treatment-driven challenges for the orthodontist. A clamping relationship between the bracket and archwire allows these reciprocal forces to be transmitted via the archwire to a group of teeth. In this manner, the reciprocal forces are spread out and dissipate to levels that fall below the physiological threshold for tooth movement.

The clamping mechanism provided by the present invention can also remove the need for additional ties or elastics between brackets for the purposes of retaining a tooth in a desired position or holding space open or closed, thereby improving the oral hygiene conditions for the patient. Finally, the ability to lock-down an entire group of teeth in position on an archwire effectively enjoins that whole group for a superior anchorage, or enables a group of teeth (e.g., the anterior teeth) to be moved en mass via posterior traction.

### SUMMARY OF THE INVENTION

This invention provides an orthodontic bracket having an eccentric cam mechanism for pushing a movable jaw toward a fixed jaw to capture an archwire with a significant force. An elastomeric insert can also be held between the jaws to grip the archwire. Different inserts providing a wide range of degrees of friction can be employed to meet the requirements of individual teeth over the course of treatment. In addition, the inserts can be individually configured to convey statistically-known, ideal torque, angulation and prominence values, thereby making a system of inserts appropriate to deliver corrective forces as part of an orthodontic treatment philosophy.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a perspective view of the base 10, bonding pad 12, and fixed jaw 20 of an orthodontic bracket embodying the present invention.

FIG. 2 is a perspective view of the movable jaw 30 assembled with the base 10 and fixed jaw 20 from FIG. 1.

FIG. 3 is a perspective view of the instrument 60 used to actuate the cam screw 40 of the bracket assembly.

FIG. 4 is a perspective view of the movable jaw 30 and cam screw 40.

FIG. 5 is a perspective view of the underside of the movable jaw 30 and cam screw 40.

FIG. 6 is a perspective view of the base 10 and fixed jaw 20.

FIG. 7 is a perspective view of the movable jaw 30 and cam screw 40 on the base 10 in the fully open position.

FIG. 8 is a perspective view of an insert 50 including a rotation wedge portion 54 and a bidirectional hook structure 56.

FIG. 9 is another perspective view of the insert 50 corresponding to FIG. 8.

FIG. 10 is a perspective view of the bracket assembly, with an elastomeric insert 50 in place, in the closed position.

FIG. 11 is another perspective view of the bracket assembly, with an elastomeric insert 50 in place, in the closed position.

FIG. 12 is a perspective view of the bracket assembly in the intermediate open position to enable removal of an archwire while retaining the insert 50.

FIG. 13 is a perspective view of an insert 50 snapped into corresponding retentive features in the base 10 to engage the fixed jaw 20.

FIG. 14 is a detail perspective view showing the cam lobe 45 of the cam screw 40 engaging the notch 17 in the slot 15, with the cam screw 40 oriented as it would be with the assembly in the intermediate open position.

FIG. 15 is a perspective view of the cam screw 40.

FIG. 16 is a perspective view of an alternative embodiment of an elastomeric insert 50 pre-positioned on an archwire 70.

FIG. 17 is a perspective view of a series of inserts 50 pre-positioned on an archwire 70.

FIG. 18 is a perspective view of the archwire 70 and inserts 50 from FIG. 17 assembled with brackets.

### DETAILED DESCRIPTION OF THE INVENTION

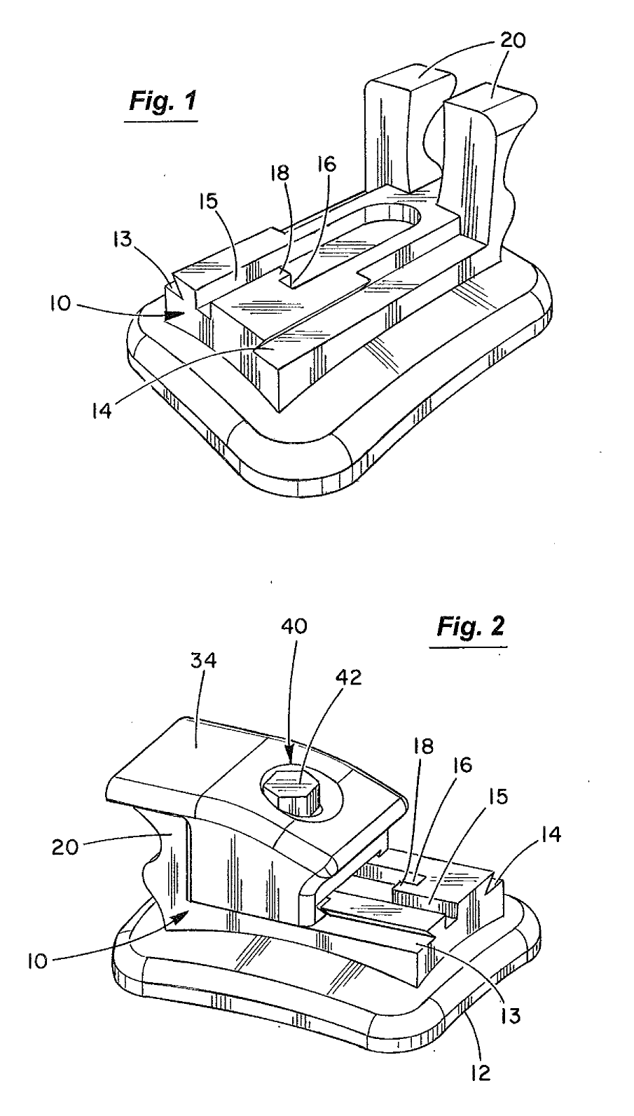

The major components of the present orthodontic bracket include a fixed jaw 20 extending outward from a base 10, and a movable jaw 30 with an eccentric cam mechanism for driving the movable jaw 30 toward the fixed jaw 20 to capture an archwire between the jaws 20, 30. FIG. 1 is a perspective view of the base 10, bonding pad 12 and fixed jaw 20. The bonding pad 12 can be a conventional mesh bonding pad 12 that is brazed onto the base 10 after it is produced via a metal injection molding (MIM) process. However, there are advantages to incorporating the bonding surface into the base 10 and fixed jaw 20 as one piece.

FIG. 2 is a perspective view showing the initial assembly position of the movable jaw 30 to the base 10 of the bracket. With the movable jaw 30 positioned as far gingivally as possible, the tracks 13, 14 on the base 10 are oriented properly for sliding engagement with the corresponding channel 32 on the underside of the movable jaw 30 (shown in FIGS. 4 and 5). Then, the movable jaw 30 can slide occlusally into its working range.

FIG. 15 is a perspective view of the cam screw 40. The term “cam” is included in the name due to the fact that one feature is a non-concentric or eccentric cam lobe 45. The shaft of the cam screw 40 passes concentrically through the movable jaw 30 with the head 42 of the cam screw 40 remaining accessible from the outer surface of the movable jaw 30. FIG. 5 illustrates a perspective view from the underside of the movable jaw 30 and cam screw 40. It can be seen that the cam screw 40 has a collar 44 residing in a shaped nest in the underside of the movable jaw 30. The nest is configured to limit the rotation range of the cam screw 40 to about 90 degrees.

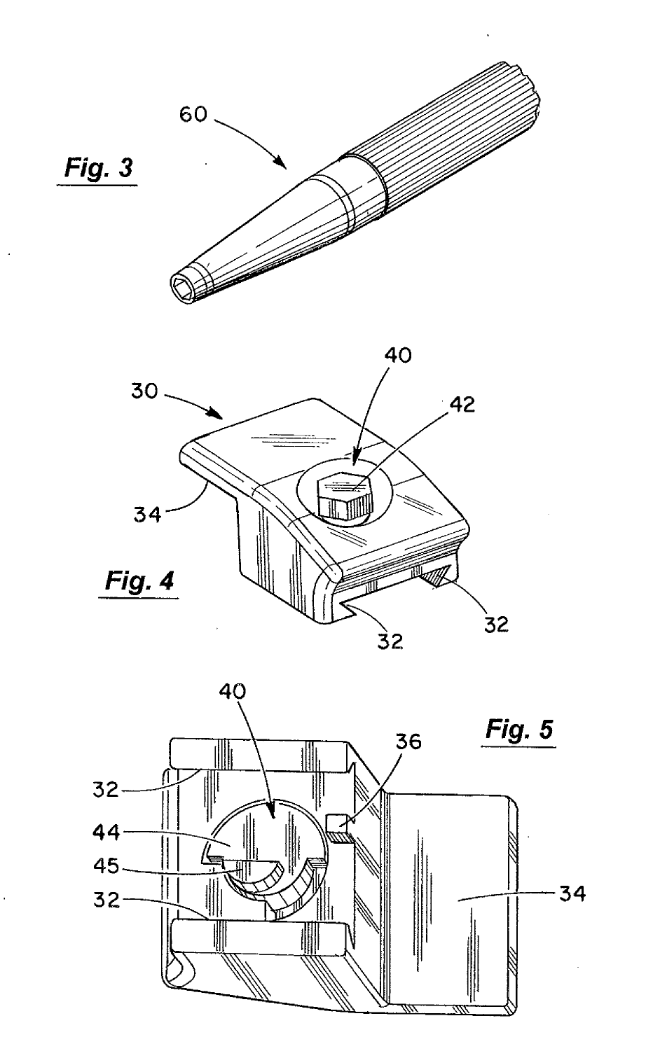

The upper end of the cam screw 40 has a hex head 42 or other conventional head suitable for engaging a tool to rotate the cam screw 40. For example, FIG. 3 is a perspective view of an instrument 60 with a socket designed to engage the hex head 42 of the cam screw 40.

The cam lobe 45 can also be seen in FIGS. 15 and 5. While the cam lobe 45 is in the rotational orientation shown in FIG. 5, the cam lobe 45 can slide freely along a slot 15 on the upper surface of the base 10 of the bracket assembly, provided the cam screw 40 is rotated and oriented accordingly. This slot 15 is depicted in FIGS. 1, 2 and 6. Thus, while the cam lobe 45 is in this rotational orientation, translation of the cam lobe 45 along the slot 15 permits the movable jaw 30 to slide along the tracks 13, 14 on the base 10 in a gingival-occlusal direction between its open and closed positions, as will be discussed below.

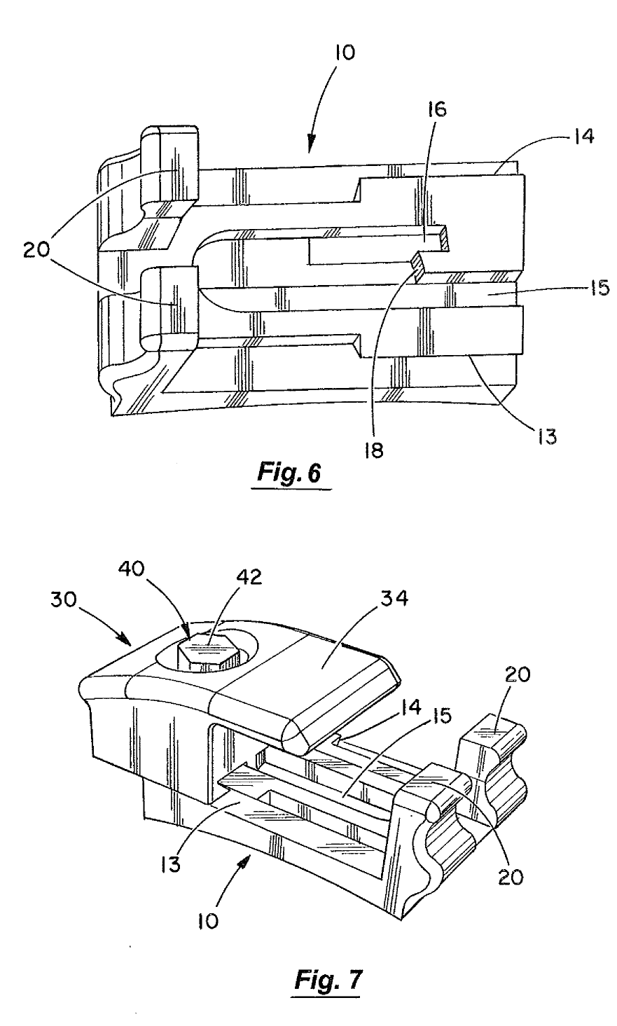

A dog 36 on the underside of the movable jaw 30 (shown in FIG. 5) limits the range of sliding motion of the movable jaw 30 in the occlusal direction. The dog 36 extends into and slides along the second channel 16 shown in FIG. 6. In FIG. 7, the bracket is fully open with the limiting dog 36 maxed out, so that the movable jaw 30 can open no further.

In this fully open configuration, the bracket is ready to receive an elastomeric insert 50, which can drop in between the fixed jaw 20 and movable jaw 30. The insert 50 is intended to reside in the channel defined by the space between the fixed jaw 20 and movable jaw 30 when closed, running mesial-distally through the bracket for receiving and engaging an orthodontic archwire. The insert 50 is sufficiently malleable or compressible to capture the archwire between the jaws 20, 30 when the movable jaw 30 is moved to its closed position.

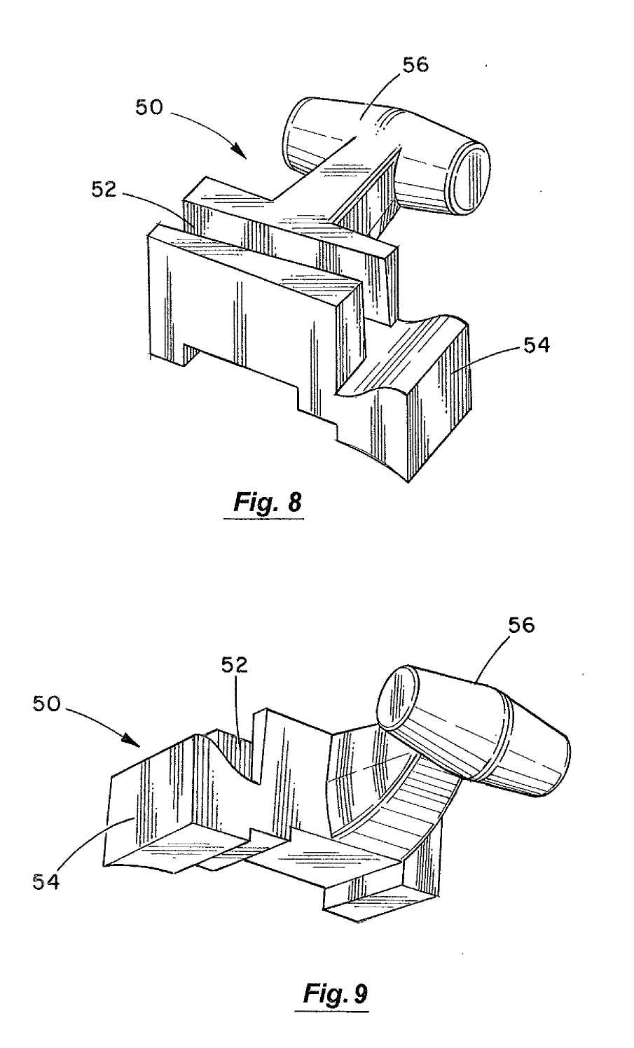

An example of an elastomeric insert 50 is depicted in FIGS. 8 and 9. The elastomeric insert 50 can be formed, for example, from a hard urethane or hard silicone rubber, and as such it has elastic, rubbery properties and is slightly compressible. The insert 50 can also include a barrel-shaped structure 56 that serves as a bidirectional gingival elastic hook, which may be present on the insert 50 for some brackets but absent on others. This elastic hook 56 can be easily trimmed away at chair side if it is not needed.

The material composition and design of the insert 50 allows for many desirable features that the practitioner selects for the individual patient defining the key advantage of patient-specific inserts. Specifically, it is in the elastomeric insert 50 that one might intentionally allow contact and clamping against the archwire. Alternately, a hard urethane insert would provide rigid walls for traditional tip, torque and rotation control found in a passive self-ligating bracket design.

The inserts 50 could be replaceable, with different insert sets being used for cases where a change in tooth position or bracket play is prescribed by a doctor. In other words, not all inserts would be expected to clamp down. Others might engage the archwire in a normal manner allowing sliding friction. For example, these inserts 50 could be manufactured using additive processes, such as 3D printing or other rapid prototyping processes. Rapid prototyping technology is rapidly advancing, and such machines can be used to lay down soft-to-hard elastomeric parts of this size range. Elastomeric inserts 50 could be produced as custom components dedicated to the needs of an individual patient.

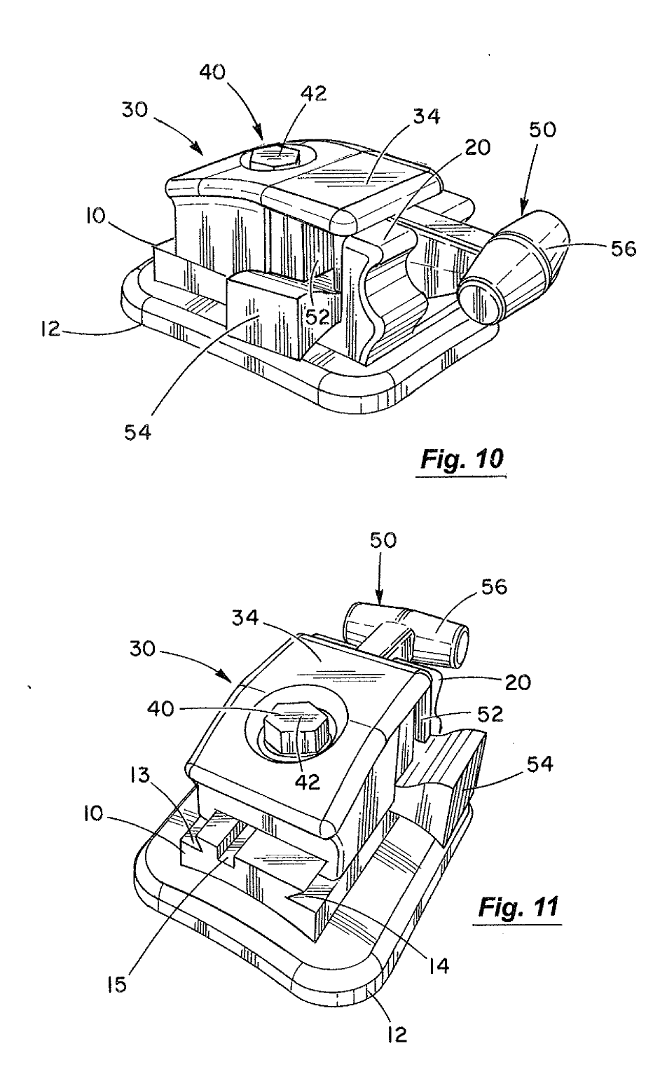

The insert 50 snaps into the notch in the fixed jaw 20, as shown in FIGS. 10-13. The lateral facets of the arm supporting the elastic hook 56 of the insert 50 can be formed with a draft of about 8 degrees to interwork with the facets of the notch in the fixed jaw 20. The interworking of these surfaces along with other registration between the insert 50 and the fixed jaw 20 serve to positively hold the insert in the fixed jaw 20, preventing it from coming loose in the mouth, or falling out of position once inserted while the assembly is in the fully-open position. The insert 50 has to be pushed into engagement with the fixed jaw 20 with a positive force. After the insert 50 has been placed between the jaws 20 and 30, an archwire can be inserted into the archwire channel 52 through the insert 50.

Next, the movable jaw 30 is moved from its open position to its closed position to retain the insert 50 and archwire between the jaws 20, 30. This is done by manually sliding the movable jaw 30 in a gingival direction toward the fixed jaw 20 along tracks 13, 14 on the base 10. The door portion 34 of the movable jaw 30 slides over the insert 50, and thereby captures the insert 50 and archwire in the region between the jaws 20, 30.

After the movable jaw 30 and the cam lobe 45 on the cam screw 40 have moved sufficiently far in the gingival direction to clear the narrower occlusal portion of the slot 15, the cam screw 40 can be rotated via a tool 60 by about 90 degrees. This causes the cam lobe 45 to rotate against a cam-follower surface 18 on the base of the bracket (shown in FIG. 6). The cam lobe 45 is configured to go slightly past center, so as to be self-retained positively in the locked closed position. The camming action between the cam screw 40 and cam-follower surface 18 exerts a significant force pushing the movable jaw 30 toward the fixed jaw 20, and squeezing the insert 50 and archwire between the jaws 20 and 30. In the embodiment shown in the accompanying drawings, the cam-follower surface 18 is formed by the curved end of the tongue material between the narrower occlusal segment of the slot 15 and the channel 16 for receiving the dog 36 in the base 10 of the bracket. When the movable jaw 30 is pushed into contact with the insert 50, and the cam lobe 45 is rotated into the closed position, the insert 50 is compressed slightly, perhaps by 0.0025 to 0.003 in. Depending on the configuration of the jaws 20 and 30, the insert 50 and the archwire, the archwire can be firmly clamped between the jaws 20 and 30 with any desired degree of force.

It should be understood that other shapes and configurations for the insert 50 could be readily substituted. In addition, a wide variety of materials could be used for the insert 50. The present orthodontic bracket could also be employed without an insert, or with other types of cushioning or gripping materials between the jaws 20, 30 and the archwire.

The reader will note the wedge structure 54 extending from the insert 50 beyond the opening of the arch slot in FIGS. 10-13. The wedge structure's 54 bottom surface rests against the outer extent of the bonding pad 12. Positioned as such, the reader should understand that the wedge structure 54, being elastomeric, would bias the archwire emerging from the archwire slot to cause rotation of the tooth about its long axis. The insert 50 may have such rotation wedges 54 on both its mesial and distal extents, and since both will never be needed together, either or both of the rotation wedges 54 can be trimmed off at chair side as needed.

The present invention should also be viewed as providing a system of brackets and inserts suitable for use in a typical orthodontic practice. First, a limited number of types of the steel assemblies may be required to treat all of the teeth. Accommodation of the requirements for each tooth can be handled by the inserts. In other words, demonstration of the appropriate torque, angulation rotation values and prominence for each tooth can be engineered into the configuration of the inserts rather than the steel bracket assemblies themselves. For example, an extensive series of inserts 50 could be adequately contained using around four or five basic steel assemblies. The inserts 50 would impart values for torque, angulation and with different configurations of the rotation wedges, correction in terms of rotation could also be accomplished. Along with the archwire, the inserts 50 can be the force-generating portion of the system. The present invention contemplates the left- and right-handedness of a universal steel bracket assembly could be determined by the insert 50. The angulation value or prominence of the bracket assembly could be set by either the bracket assembly or the insert, or by a combination of both.

A “normal” series of inserts would impart the statistically-known normal prescription values to the teeth. Alternate series of inserts would be available to provide torque and angulation values above and below the normal values to address the response of a case and to tailor appropriate physiological forces to actual teeth based on the observed movement as the case progresses.

The inserts could also utilize a series of inserts 50 of progressive hardness over time to achieve tooth movement. For example, a tooth may be at first be treated with a comparatively-passive insert and then later, an active insert formed from a stiffer material may be inserted in a bracket. The present invention enables the concept of a progressive series of inserts to be mixed with the practitioner's need for a locked-down mode insert.

During orthodontic treatment, a practitioner will typically need to remove an archwire and replace it with another. At the time of switching-out of the archwire, it is helpful if the door portion 34 of the movable jaw 30 remains partially over the insert 50. In that position it serves to avoid a situation where the insert 50 escapes from the bracket and becomes loose in the mouth. Should the insert 50 become loose in the mouth, it poses the hazard of aspiration. The present invention allows the doctor (or staff) to quickly position the movable jaw 30 in a less than full-open position, where the door portion 34 of the movable jaw 30 partially restrains the insert 50 in the bracket assembly.

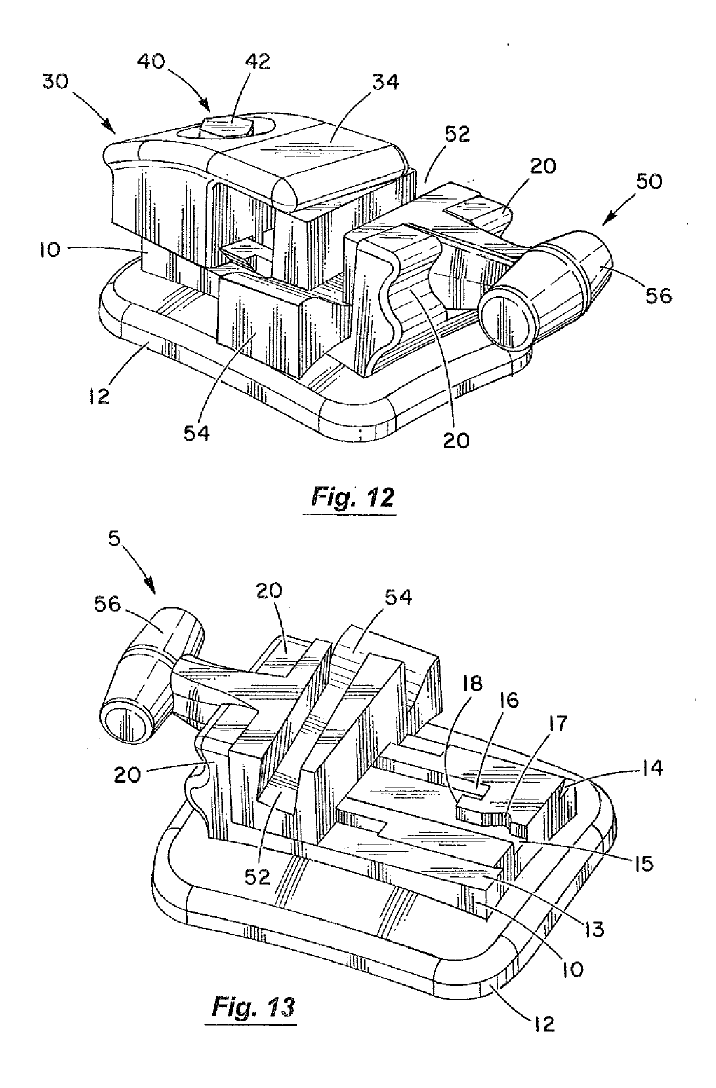

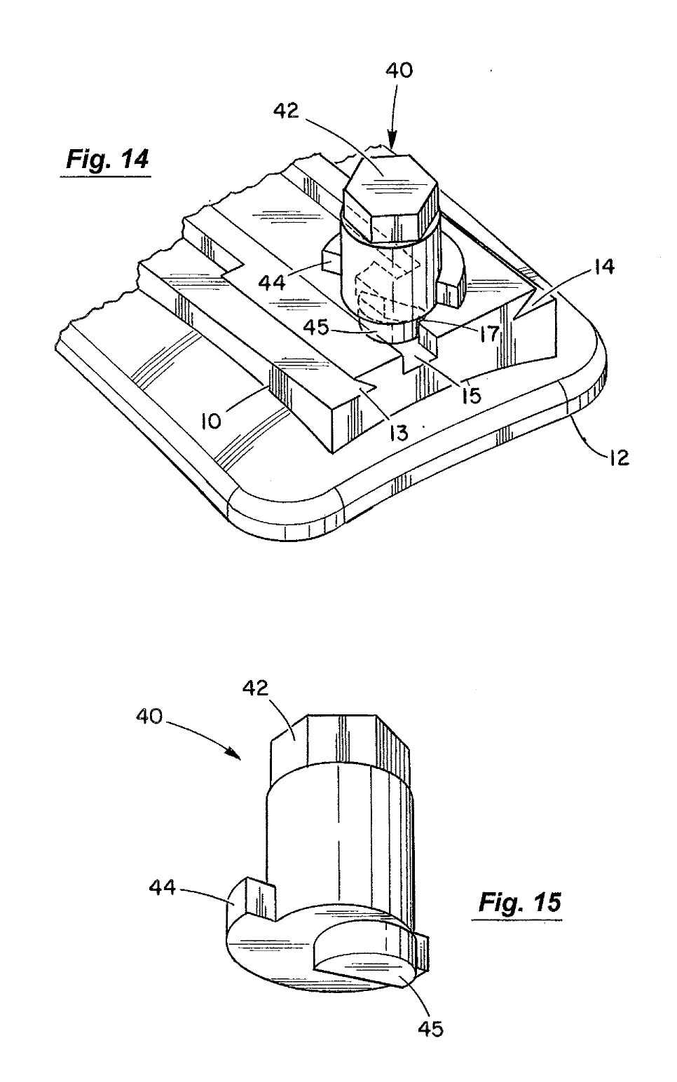

In FIG. 12, the movable jaw 30 and its door 34 are positioned to allow the archwire to be changed out. For the doctor or staff to quickly position the movable jaw 30 in that position, an intermediate notch 17 (shown in FIG. 13) can be formed in the slot 15 mentioned earlier, where the cam lobe 45 can slide to the intermediate-open position. By applying a moderate counter-clockwise rotational force to the cam screw 40, while simultaneously sliding the movable jaw 30 occlusally, the corner of the cam lobe 45 will fall into this notch 17 as shown in FIG. 14.

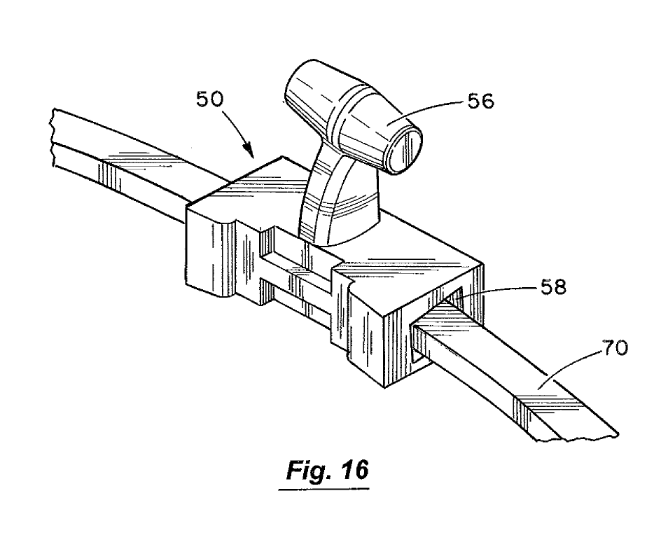

FIGS. 16-18 illustrate an alternative embodiment of an elastomeric insert 50 having a hole or passageway 58 extending through the insert 50 in a generally mesio-distal direction. The archwire 70 is initially inserted through this passageway 58 in the insert 50 prior to assembly with the remainder of the bracket. This is in contrast to the three-sided channel 52 in the previous embodiment of the insert 50 shown in FIGS. 8-13. The embodiment shown in FIGS. 16-18 is fabricated for positive seating of the archwire 70 within the insert 50, and is anticipated to provide precise positioning characteristics with reduced play as needed in orthodontic finishing. For example, the inserts can be curved on both their labial and lingual walls of the hole 58 to follow the normal curvature of an archwire 70.

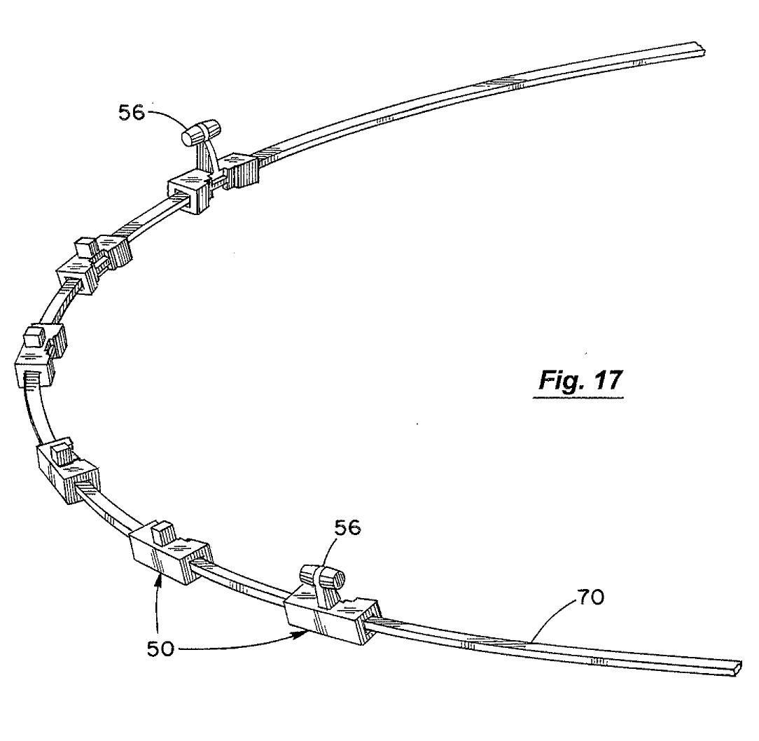

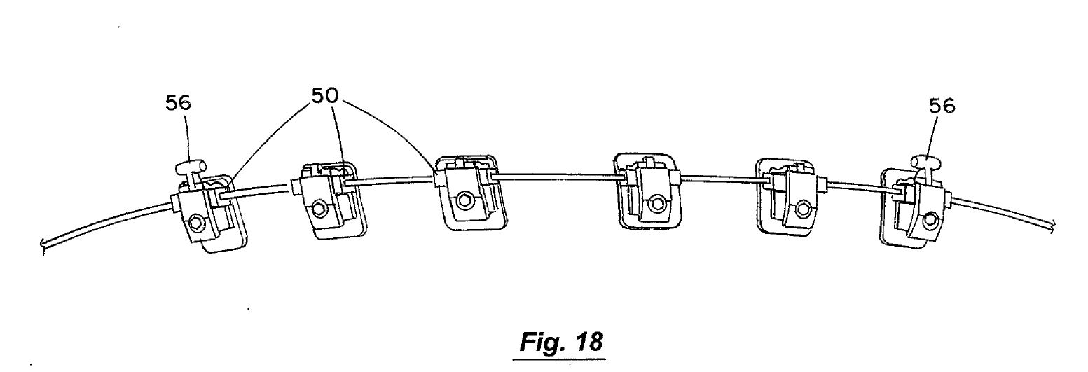

This embodiment also enables a series of inserts 50 to be pre-positioned at intervals along an archwire, as shown in FIGS. 17 and 18. A series of morphologically-shaped archwires can be tailored to more aesthetically handle the shape of the anterior teeth and cuspids. For example, these archwires can be characterized as having a flatter anterior segment (i.e., having a larger radius), and then “turning the corner” at the cuspids. The archwires can also be offered in a variety of sizes. Also, this allows the practitioner to prepare an appropriate archwire, along with the appropriate array of inserts, prior to the patient's appointment, leaving insertion of the system into the brackets by auxiliary staff.

As previously mentioned, some conventional self-ligating brackets provide either a passive mode or an active mode, neither of these modes prevents translation of the bracket with respect to the archwire. It should be noted that the present invention carries the passive/active concept further in allowing a third mode—a lock-down mode that allows clinical advantages when delivering orthodontic forces to individual teeth as well as groups of teeth.

The lock-down mode for a single tooth can be a distinct advantage in a myriad of situations. The most obvious advantage of using a locked-down mode for individual teeth is removal of the play in the slot resulting in the delivery of the full expression of the internal slot prescription. Other examples of everyday advantages of the lock-down mode sees the archwire being locked in a single point anteriorly to prevent skewing of the archwire's midline. This advantage relieves the practitioner of the need for crimpable or composite stops as crowding unravels within passive slots posteriorly. Further into treatment stages, a single tooth that has been bodily translated into its desired position along the slope of an archwire may be married to such a point through lock-down mode. A single tooth locked-down to a wire could providing an abutment for moving an adjacent tooth, using a conventional compression or tension coil spring. This means that the lock-down tooth will not suffer any undesirable reciprocal movement as it serves as a locked-down abutment for an archwire-borne compression or tension spring.

A lock-down function also holds many advantages for groups of teeth. Lock-downs for dental groups within their respective bracket slots have many useful applications such as holding space closed without the need for unhygienic continuous ligature ties, tiebacks or elastic chains. In addition, these internal lock-downs can freeze entire dental arches or multi-tooth segments for desired group movements with elastics. Manipulation of entire dental segments is often desirable when resolving tooth size discrepancies and midline discrepancies.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. An orthodontic bracket comprising:
a base;
a fixed jaw extending from the base;
a movable jaw slidably engaging the base and defining a region between the jaws for receiving an archwire;
a camming mechanism driving the movable jaw toward the fixed jaw to capture an archwire in the region between the jaws.

2. The orthodontic bracket of claim 1 further comprising an elastomeric insert for holding an archwire in the region between the jaws.

3. The orthodontic bracket of claim 2 wherein the elastomeric insert further comprises a channel extending through the elastomeric insert for receiving an archwire.

4. The orthodontic bracket of claim 2 wherein the elastomeric insert further comprises a passageway extending through the elastomeric insert for receiving an archwire.

5. The orthodontic bracket of claim 1 wherein the camming mechanism further comprises:
a rotatable shaft with an eccentric cam lobe on the movable jaw; and
a cam-follower surface on the base contacted by the cam lobe as the shaft is rotated.

6. The orthodontic bracket of claim 5 wherein the shaft extends through the movable jaw and further comprises an exposed head for rotating the shaft.

7. The orthodontic bracket of claim 1 wherein the movable jaw further comprises a door extending over the region between the jaws as the movable jaw slides toward the fixed jaw to capture an archwire in the region between the jaws.

8. The orthodontic bracket of claim 1 further comprising a track on the base slidably engaging the movable jaw.

9. An orthodontic bracket comprising:
a base;
a fixed jaw extending from the base;
a track on the base;
a cam-follower surface on the base;
a movable jaw sliding on the track and defining a region between the jaws for receiving an archwire;
a cam screw driving the movable jaw along the track toward the fixed jaw to capture an archwire in the region between the jaws, said cam screw having:
(a) a shaft extending through the movable jaw;
(b) an exposed head for rotating the shaft; and
(c) an eccentric cam lobe on the shaft contacting the cam-follower surface as the shaft is rotated to drive the movable jaw toward the fixed jaw.

10. The orthodontic bracket of claim 9 further comprising an elastomeric insert for holding an archwire in the region between the jaws.

11. The orthodontic bracket of claim 10 wherein the elastomeric insert further comprises a channel extending through the elastomeric insert for receiving an archwire.

12. The orthodontic bracket of claim 10 wherein the elastomeric insert further comprises a passageway extending through the elastomeric insert for receiving an archwire.

13. The orthodontic bracket of claim 9 wherein the movable jaw further comprises a door extending over the region between the jaws as the movable jaw slides toward the fixed jaw to capture an archwire in the region between the jaws.

14. An orthodontic bracket comprising:
a base;
a fixed jaw extending from the base;
a movable jaw slidably engaging the base and defining a region between the jaws for receiving an archwire, said movable jaw having a door extending over the region between the jaws as the movable jaw slides toward the fixed jaw;
an elastomeric insert insertable into the region between the jaws; and
a camming mechanism driving the movable jaw toward the fixed jaw to capture an archwire in the region between the jaws; wherein the door covers the region between the jaws and captures the elastomeric insert and archwire as the movable jaw slides toward the fixed jaw.

15. The orthodontic bracket of claim 14 wherein the camming mechanism further comprises:
a rotatable shaft with an eccentric cam lobe on the movable jaw; and
a cam-follower surface on the base contacted by the cam lobe as the shaft is rotated.

16. The orthodontic bracket of claim 14 wherein the elastomeric insert further comprises a channel extending through the elastomeric insert for receiving an archwire.

17. The orthodontic bracket of claim 14 wherein the elastomeric insert further comprises a passageway extending through the elastomeric insert for receiving an archwire.
